(19) United States
(12) Patent Application Publication
(10) Pub. No.: US 2019/0240881 A1
(43) Pub. Date: Aug. 8, 2019

(54) INTEGRATED ARTICLES WITH SUBSTANTIALLY SEAMLESS, PREFERABLY SUBSTANTIALLY FAULTLESS SHELLS AND PREPARATION THEREOF

(71) Applicants: BASF SE, Ludwigshafen am Rhein (DE); Qingdao HAIGAO Design & Manufacturing Co., Ltd., Qingdao (CN)

(72) Inventors: Jun GU, Shanghai (CN); Yang Chun ZHOU, Shanghai (CN); King Shan WONG, Shanghai (CN); Feng GU, Shanghai (HK); Feng Chao HU, Shanghai (CN); Li Li WANG, Burwood East (AU); Jian WU, Qingdao (CN); Hongtao LI, Qingdo Sahandong (CN); Shaoyun LIU, Qingdao (CN); Xiaodong ZHOU, Qingdao (CN)

(21) Appl. No.: 16/342,638

(22) PCT Filed: Oct. 13, 2017
(86) PCT No.: PCT/EP2017/076218

§ 371 Date: Apr. 17, 2019

(30) Foreign Application Priority Data
Oct. 18, 2016 (CN) PCT/CN2016/102449

(51) Int. Cl. B29C 44/08; B29C 67/24

(52) U.S. Cl. CPC B29C 44/08; B29C 44/14; B29C 67/246

(57) ABSTRACT

An integrated article including a substantially seamless or substantially faultless shell and a core. The core may be a foamed core placed within the shell. Disclosed are preparation methods of the article. Also disclosed is a refrigerator door with a substantially seamless or substantially faultless shell and a foamed core. The shell and the core are combined into a single, integrated body. A method of preparing the refrigerator door via Reaction Injection Molding is disclosed.

### TECHNICAL FIELD

The present invention relates to an integrated article with a substantially seamless, preferably substantially faultless shell and a core, preferably a foamed core placed within the shell, and to the preparation thereof. Particularly, the present invention relates to a refrigerator door with a substantially seamless, preferably substantially faultless shell and a foamed core, wherein the shell and the core are combined into a single, integrated body, and to the preparation thereof via Reaction Injection Molding (referred to as “RIM” hereafter).

### PRIOR ART

Integrated articles with substantially seamless, preferably substantially faultless shells and cores, preferably foamed cores have significant advantages, yet their production can be troublesome.

Taking a refrigerator door as an example, in order to achieve good heat insulation and mechanical strength, the refrigerator doors having following features are advantageous: i) a foamed core is placed with in a shell; ii) the foamed core and the shell are combined into a single, integrated structure to improve the strength of the refrigerator door, iii) the shell should be substantially seamless, preferably substantially faultless in order to prevent penetration of outside substance into the foamed core. However, having all the three features at the same time can be difficult in industrial production. Firstly, the presence of the foamed core restricts the formation conditions of the shell. The foamed core has poor strength and heat resistance and can be damaged easily by high temperature and high pressure. This means that high temperature and high pressure should be avoided during the formation of the shell at locations close to the foamed core. On the other hand, high temperature and high pressure are commonly used in plastic molding. Secondly, to place the foamed core at a proper position, some kind of supporting device is necessary. However, such supporting device can easily leave faults on the shell, resulting in communication between the foamed core and the environment outside the shell. Therefore, it is difficult to obtain a shell which is substantially seamless, preferably substantially faultless, with a foamed core placed inside. Finally, when the foamed core and the shell is molded separately, it is difficult to combine them into a single, integrated body without damaging the foamed core.

It is apparent that, when the core is resistant to high temperature and high pressure, the preparation of the inventive article can be easier. However, even in such case, the preparation will still encounter process complexities.

In prior art, RIM has been used to produce high density polyurethane (referred to as “PU” hereafter) microporous foamed core in order to produce PU refrigerator doors. Such refrigerator doors have improved heat insulation due to the presence of the pores in the foamed core, however, the improvement is limited as the density of the foamed core is too high.

It was also proposed to insert a vacuum heat insulation plate into a PU foamed core to enhance heat insulation. Such an approach is disadvantage in that, due to the poor reliability of the vacuum heat insulation plate, as time goes, outside substances penetrate into the vacuum heat insulation plate, causing deterioration in heat insulation performance.

Therefore, it is desirable to obtain such a refrigerator door, which has a foamed core enclosed by a substantially seamless, preferable substantially faultless shell, so that heat insulation is improved by the presence of pores in the foamed core, while the substantially seamless, preferable substantially faultless shell isolates the foamed core from outside environment, so that heat insulation can be maintained over time.

As an attempt in obtaining such refrigerator doors, CN103913035A disclosed the preparation of a refrigerator door with a foamed core and a substantially seamless shell. The foamed core is prepared separately and placed in the molding cavity of the mold of a RIM device, with empty space around the foamed core. A substantially seamless shell is formed by RIM in the empty space so that the shell encloses the foamed core within itself. Such an approach is disadvantageous in the following aspects: i) the foam will deform under the pressure in RIM due to its low strength, compressing the gap at the side of the foam facing the mold or even compact it. Therefore, it is easy to form faults on the surface. Meanwhile, as the core needs to be secured on the supporting devices on the inner wall of the mold, it is inevitable to form faults on the shell, resulting in communication between the inner core and the environment outside the outer shell. This enables the penetration of outside substance into the pores in the core, and reduced heat insulation performance of the core; ii) the whole shell is produced from expensive RIM material, driving the overall cost higher; iii) the side of the refrigerator door facing foodstuff stored in the refrigerator is produced from PU, which brings about food safety concerns.

As a similar embodiment, CN104339531A disclosed a process to produce an integrated article with a substantially seamless shell and a core enclosed inside the shell by dual-color injection. However, dual-color injection has limited application as it involves expensive and complicated mold, and has certain requirements on the material used for injection. Moreover, dual-color injection is not suitable for those articles with foamed cores as it involves high temperature and high pressure which will damage the foamed cores.

### SUMMARY

The present invention relates to a article with a substantially seamless, preferably substantially faultless shell made of at least two parts, said shell encloses a core inside, wherein the shell and the core is combined into a integrated structure.

Preferably, said shell is substantially faultless.

Preferably, the core is a foamed core.

Further preferably, said foamed core is produced from PU foaming resin, the density of the PU foamed core is 30-80 kg/m³ and preferably 40-80 kg/m³, and free foaming density of the PU foaming resin is preferably 10-40 kg/m³.

The article is, for example, a refrigerator door.

The process for the production of the article of the present invention comprises the following steps:

(a) Form the first part of the shell with first shell material.

(b) Form the core, preferably the foamed core, with the core material on the first part of the shell, forming the combination of the first part of the shell and core.

(c) Form the second part of the shell outside the core with the second shell material, wherein the first and the second parts of the shell forms a substantially seamless, preferably substantially faultless shell enclosing the core, so that the final article is obtained.

Preferably, in step (c), the core and second part of the shell is further combined, so that the final article is formed into a single, integrated structure.

Preferably, step (c) is implemented using a method which doesn't involve higher temperature and high pressure, such as RIM, so that the core, preferably the foamed core is not damaged by higher temperature and high pressure in step (c).

Preferably, steps (a) and (c) can form the first and the second parts of the shell with desired shaped and color. Further preferably, with proper selection of the second shell material, the second part of the shell having desired shape and color can be formed in step (c) by simple, direct injection using RIM method.

Said steps (a), (b) and (c) can be implemented using known methods under known conditions.

The first shell material, the core material and the second shell material can be known materials. Selection of said materials enables the formation of a single, integrated structure of the first and second part of the shell and the core via binding. That is, the selection of the first shell material and the core material enables the formation of the combination of the first part of the shell and the core via binding, and the selection of the first and the second shell materials enables the formation of the substantially seamless shell via binding, and the selection of the second shell material and the core material enables the formation of the combination of the first part of the shell and the core via binding. With these, a integrated structure can be formed. Preferably, the second shell material should have good flowability, adhesion to the first part of the shell and wettability and adhesion to the core.

Preferably, said first shell material, core material and the second shell material can be polystyrene (referred to as “PS” hereafter) resin, PU foaming resin and PU elastomeric RIM resin, respectively, which can be commercially available material. However, the present invention is not limited to this. For example, the second shell material can be epoxide resin, organic silicone resin, unsaturated resin and so on, which can form a shaped article via injection of single-component or mixed multi-component liquid raw material followed by curing.

Known additives can be added to the first and the second shell materials and the core material so that desired properties can be imparted to the first part of the shell, the second part of the shell and/or the core. For example, pigments or dyes can be added to the first and the second shell materials and the core material to impart desired color to the first and the second parts of the shell and the core.

The first and the second parts of the shell can be machined in a known manner to impart certain performances and/or appearance, such as shape, color or strength. It is also possible to form pictures or patterns by itching or engraving, so as to produce articles with 3D patterns and with certain texture on the surface.

Steps (a), (b) and (c) can be implemented in various known manner to impart desired properties to the parts, such as shape, color and strength.

The present invention can produce articles at small to big scale at low cost, and it is easy to be automate the production.

The substantially seamless, preferably substantially faultless article of the present invention is not limited to two parts, and can be made of more than two parts. As different parts can be produced in separated steps, the shell of the article of the present invention can be easily customized without rendering the process of the present invention too complicated. For example, the insert mentioned below can be considered a third part of the shell other than the first and the second shell.

Various inserts, such as display units, vacuum heat insulation plates and RF devices can be placed in the shell of the present invention. Inserts can be at least partly embedded in the shell. As the shell of the present invention is substantially seamless, preferably substantially faultless, the structure of the article is more stable, and the insert can work more reliably.

When it is necessary to put an insert into the shell, the insert can be combined with the shell, and integrated into one body with the surrounding shell material during molding. The process to do so is known to those skilled in the art.

At least a part of the shell of the present invention can be process in a manner that is different from the remaining part of the shell, so that the part can be customized simply and quickly at low cost and in a small number. This is in line with current industrial trend, and is difficult to be achieved in a conventional way. For example, it is possible to produce the part at a bigger thickness, then have the thicken part engraved, or use an exchangeable molding to form the part so as to customize the part while keeping the remaining part of the shell unchanged.

In prior art technologies exemplified by CN103913035A, it is essential to place the core in the cavity of the mold and leave sufficient space around the core for the formation of the shell by, for example, RIM. In contrast, in the present invention, such operation is not necessary. The first part of the shell and the core can be placed in the mold for the formation of the second part of the shell. The operation is simple and reliable.

Furthermore, as there is no need to have a supporting device secured on the inner surface of the mold to support the core, the shell will be free of faults left by the supporting device. This prevents deterioration of heat insulation performance over time caused by penetration of outside substance into the pores of the foamed core.

Finally, the final article can be processed by direct spray painting, lamination with film, direct polishing or in mold coating so as to obtain certain decorative effect.

### DESCRIPTION OF THE FIGURES

FIGS. 1 and 2 show a specific embodiment of the present invention, wherein an integrated refrigerator door with a substantially seamless, preferably substantially faultless shell and a foamed core is produced. FIG. 1 shows the closed first mold and combination of the formed first part of the shell and foamed core at the end of step (b). FIG. 2 shows the closed second mold and the formed integrated refrigerator door with the first and the second parts of the shall and the foamed core.

FIGS. 3 a, b and c respectively show the completed first part of the shell, the combination of the first part of the shell and the foamed core, and the integrated refrigerator door with the first, second parts of the shell and the foamed core.

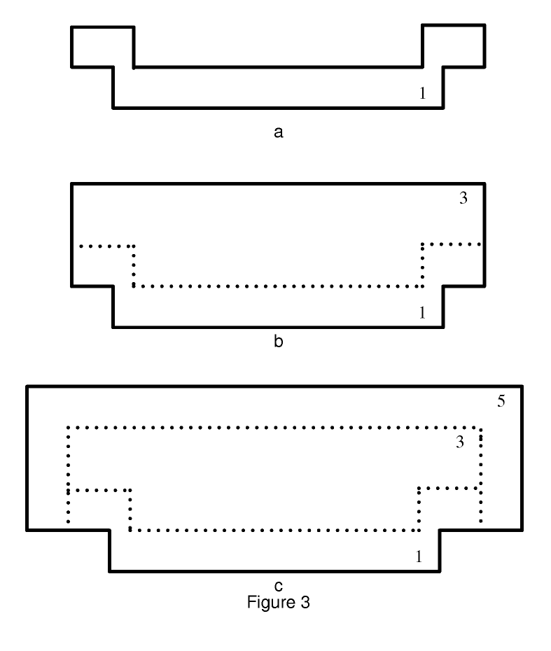

FIGS. 4a and 4b shows the appearance of the refrigerator door under various conditions.

### SPECIFIC EMBODIMENTS

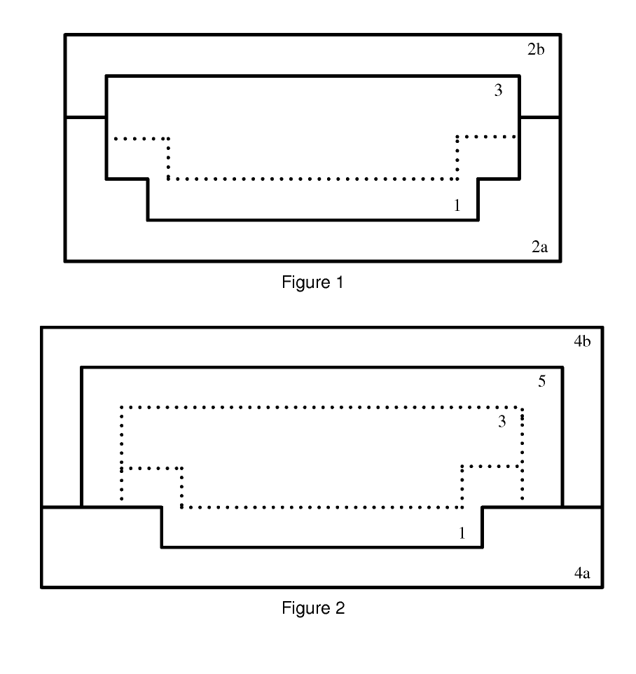

A specific embodiment of the present invention is illustrated with reference to FIGS. 1 and 2, wherein a substantially seamless, preferably substantially faultless integrated refrigerator door is produced. The first part of the shell is the liner plate facing the internal space of the refrigerator for foodstuff. The second part of the shell is the panel facing the external space outside the refrigerator. The core is the foamed core inside the refrigerator door. The first and the second parts of shell and the foamed core are produced from PS resin, PU foaming resin and PU elastomeric resin, respectively. The panel of the refrigerator door is made by RIM.

Step (a): Form PS liner plate 1, i.e., the liner plate facing the internal space of the refrigerator, by known process using PS resin.

Step (b): With the first mold 2a+2b opened, place the PS liner plate 1 at the bottom of the forming cavity of the first mold-half 2a of the first mold. Optionally, place related functional insert and structure enhancing element at proper locations. Inject PU foaming resin into the space within the first mold-half 2a of the first mold and above the PS liner plate 1. Close the first and the second mold-halves 2a and 2b of the first mold, and allow the PU foaming resin to foam and cure to obtain PU foamed core 3, with the PS liner plate 1 and PU foamed core 3 bond together to form the combination 1+3 of the PS liner plate 1 and the PU foamed core 3. Open the first mold 2a+2b to take the combination 1+3 out.

Step (c): With the second mold 4a+4b opened, place the combination 1+3 of the PS liner plate 1 and the PU foamed core 3 at the bottom of the forming cavity of the first mold-half 4a of the second mold, with the PS liner plate 1 and the bottom of the forming cavity of the first mold-half 4a of the second mold contacts each other, forming space within the forming cavity of the first mold-half 4a of the second mold, between the top and the side wall of the forming cavity, and the PU foamed core 3 (excluding the bottom of the PS liner plate 1). Optionally, place related functional insert and structure enhancing element at proper locations. Close the first and the second mold-halves 4a and 4b of the second mold, and inject PU elastomeric resin into the space within the forming cavity of the first mold-half 4a of the second mold and around the PU foamed core 3 (excluding the bottom of the PS liner plate 1), and allow the PU elastomeric resin to cure to obtain solid PU elastomer panel 5, i.e., the panel facing the space external to the refrigerator. At this time, the PU elastomer panel 5, the PS liner plate 1 and the PU foamed core 3 is bond together, forming the integrated structure 1+3+5, wherein the PU elastomer panel 5 and the PS liner plate 1 are bond seamlessly, forming a substantially seamless, preferably substantially faultless shell with a foamed core 3. Open the second mold 4a+4b to obtain the integrated refrigerator door 1+3+5 with a substantially seamless, preferably substantially faultless shell with a foamed core 3.

In such an embodiment, the PU foaming resin is a foaming system which produces low density foamed core for heat insulation. The density of the PU foamed core is 30-80 kg/m³ and preferably 40-80 kg/m³, and free foaming density of the PU foaming resin is preferably 10-40 kg/m³.

In such an embodiment, the PS resin, the PU foaming resin and the PU elastomeric resin can be known materials. Taking advantage of the adhesion of PU elastomeric resin with PU foamed core and PS liner plate, after curing, the PU elastomeric resin forms an integrated structure with the other parts, and forms substantially seamless, preferably substantially faultless shell. The PU elastomeric resin is a liquid during injection, which has good flowability, and is solid after curing, which has good adhesion with PS and foamed PU. Molding is preferably carried out under low temperature and low pressure to avoid damaging other parts, the foamed core in particular.

One or more layers of glass fiber cloth/felt and/or carbon fiber cloth/felt can be used to cover the surface of the foamed core and/or inner surface of the forming cavity of the RIM mold, which will wet with the injected resin so that the product can be enhanced.

The PU foaming resin and the PU elastomeric resin can be obtained from BASF, with its headquarter located in Ludwigshafen, Germany, as Elastocool® resin and Elastolit® resin, respectively.

In such an embodiment, by properly selecting the PU elastomeric resin, PU elastomer panel 5 with various shape and color can be obtained via direct injection by RIM in step (c), so that refrigerator with designed shape can be obtained easily.

The conditions employed in step (a) are known to those skilled in the art.

The conditions employed in step (b) can be selected from known conditions by those skilled in the art with minimal, simple experimentation. Preferably, the foaming operation is carried out under the conditions of material temperature 10-40° C., preferably about 25° C., mold temperature 15-50° C., preferably about 35° C.

The operation conditions in step (c) of the process of the present invention should ensure success of step (c) per se, and also ensure proper performance of the inventive product, such as heat insulation. Indeed, the injection of the PU elastomeric resin will inherently result in shrinkage of the PU foamed core 3, causing the increase of the density and reduction of heat insulation of the PU foamed core 3. Meanwhile, adjusting the injection amount of the PU elastomeric resin only cannot ensure the filling of the space around the foamed core 3, causing fault on the surface of the PU elastomer panel 5. Therefore, among the conditions in step (c), at least temperature, injection amount and pressure upon injection of the PU elastomeric resin should be selected to ensure high heat insulation of the PU foamed core and preferably substantially faultless of PU elastomer panel surface.

The Inventor has found that, for the PU foamed core derived from PU foaming resin and the PU elastomer panel derived from PU elastomeric resin, preferably, the injection conditions in step (c) should be: material temperature 0-90° C., preferably about 25° C., mold temperature 0-100° C., preferably 60° C., injection time<20 min. Preferably, ejection time in step (c) should be 1-20 min. By such mild conditions, the high temperature, high pressure conditions commonly used in conventional process (such as melt injection) is avoided, so as to protect the molded and foamed core from being damaged. In contrast, it is known to those skilled in the art that in melt injection molding, where linear polymer is melted by screws and injected into molds, typical temperature is 190-220° C., which will destroy PU foamed core which has been molded already by this time, and renders low heat insulation of the PU foamed core and fault on the surface of the PU elastomer panel. Although such fault can be repaired in the subsequence process to obtain the product that can avoid penetration of outside substance into the foamed core, this is clearly not preferred.

The foamed core of the present invention provides heat insulation to the refrigerator door of the present invention, and, on the other hand, is also an inset in the shell during RIM. The former need low density and high pore closure percentage, while the latter requires high density so as to counter the pressure during RIM. Therefore, a balance must be achieved between heat insulation of the refrigerator door and the strength of the foamed core. The present Inventor has found that, in order to obtain satisfactory appearance, the density of the PU foamed core should be 30-80 kg/m³ and preferably 40-80 kg/m³, and preferably the free foaming density of the PU foaming resin should be 10-40 kg/m³.

Known additives can be added to the first and the second shell materials and the core material so that desired properties can be imparted to the first part of the shell, the second part of the shell and/or the core. For example, color paste can be added to the PU elastomeric resin to impart certain color or visual effect to the refrigerator door. As the molding process doesn't involve high temperature and high pressure, color pastes that are more sensitive to heat and pressure can be used, and the color or visual effect can be controlled easier.

It is possible to further machine the refrigerator door obtained in step (c) to impart certain performance and/or appearance, such as shape, color and strength. In particular, it is possible to produce certain pattern/logo by engraving or milling on the refrigerator door panel with a thickness of 1.0-15 mm, preferably 2.0-6.0 mm, followed by finishing such as polishing or spray painting, to produce desired texture/pattern/text or visual effect. In such a way, it is possible to allow customization or personalization on the market, and produce corresponding refrigerator door in the shortest time.

The RIM in step (c) can be implemented by or followed by various known variations, so as to impart certain property to the refrigerator door. For example, it is possible to achieve decorative effect as following:

In-mold painting: the second mold is first sprayed with in-mold painting or elastomer, so that after closure of second mold, injection of PU elastomeric resin, curing and opening of the second mold, panel with certain decorative effect can be obtained, so as to reduce subsequent finishing and reduce cost.

Panel functional insert: it is possible to place a plate or film produced from plastic/organic material such as glass/stainless steel/polycarbonate or acrylate/PET or composition thereof carrying certain color, pattern or texture, as functional insert on the mold, so that after closure of second mold, injection of PU elastomeric resin, curing and opening of the second mold, panel with the functional insert on the surface can be obtained, so as to impart decorative and/or visual effect to the panel.

As mentioned above, the present invention enables quick, convenient, low cost customization of the shell in a low amount. For example, it is possible to use a partially exchangeable mold so that a 3D shape can be obtained on a part of the panel produced. In such a way, it is only necessary to change a part of the mold corresponding to the specified part of the panel, rather than changing the whole mold. It is therefore possible to change the corresponding 3D shape of the part of the panel without changing most part of the panel, so as to achieve customization of the panel while keeping most part of the process of step (c) unchanged. For another example, by designing the part of the mold corresponding to the panel, it is possible to produce the panel with a part of it having a bigger thickness, such as about 3 mm. The thick part can then be machines into desired 3D shape by, for example, thick wall sculpturing. Thus, by changing the thick wall sculpturing process, it is possible to obtain various 3D shape without changing most part of the panel, so that the panel can be customized while maintaining the process of step (c) unchanged.

Aforesaid customization method for the shell enables quick, convenient, low cost customization of the shell in a low amount. Such type of customization is in line with current trend in industry, but is difficult to be achieved conventionally. In particular, for step (c) to be successful, it is important to match the material used with mold design. That is, for a selected PU foaming resin, the second mold must be designed carefully to achieve proper molding. When the material changes, the mold may have to be changed as well. Therefore, with respect to the successful formation of the shell, it is advantageous to keep the mold unchanged. On the other hand, customization of the shell requires modification to the mold, which is contradictory to the expectation of keeping the mold unchanged. The process of the present invention has achieved the customization of the shell while maintaining the process of step (c) (the mold in particular) unchanged, which is of important industrially.

In such an embodiment, the two parts of the shell is bond with the foamed core via adhesion, utilizing adhesion capability of PU material, which saves extra process and cost, and also renders the product structure more stable.

In such an embodiment, as the inner surface of the refrigerator door is produced from food grade PS, the effect of better hygiene and safety can be achieved, and the inner surface of the door can use white color which is preferred by customers.

In such an embodiment, the seamless joint of the shell which joins PU elastomer and PS can be covered by, for example, sealing strips so that it doesn't have negative influence on appearance.

In such an embodiment, as the complicated shape of the inner surface of the refrigerator door can be formed by PS separately, the mold to produce the PS liner plate can be simple in design, which reduces cost.

In such an embodiment, as only panel 5 is made of expensive PU elastomer, the liner plate 1 is produced from cheap PS, material cost can be significantly reduced, and molding process can be implemented conveniently.

In the present disclosure, “substantially” means no less than 80% of the total, preferably no less than 90%, more preferably no less than 95%, and most preferably no less than 99%. For example, “the two parts are substantially seamlessly joined” means that the two parts are joined by joining, with the length of seamless joining is no less than 80%, preferably no less than 90%, more preferably no less than 95%, and most preferably no less than 99% of the total length of joining. For another example, “the shell is substantially seamless” means that the shell formed by combining parts with joining, with the length of seamless joining is no less than 80%, preferably no less than 90%, more preferably no less than 95%, and most preferably no less than 99% of the total length of joining. For yet another example, “the shell is substantially faultless” means that no less than 80%, preferably no less than 90%, more preferably no less than 95%, and most preferably no less than 99% of the total surface area is not occupied by faults.

In the present invention, the term “seam” regarding to the joining or shell refers to the seam in the joining between two parts of the shell that is generated due to the molding process. Therefore, the term “seamless” regarding to the joining or shell means that there is no seam of the joining or between two parts of the shell that is generated due to the molding process. For example, one part of the shell per se includes a seam because it is formed of two materials, however, the connection between two parts of the shell as no seam due to the connection, the seam on the shell should not be considered a seam in the context of the present invention, and the shell shall be considered seamless in the context of the present invention. It should be noticed that there exists processes to “repair” the seam formed during molding. For example, a patch which can adhere to the shell effectively can be used to repair the seam on the shell. Such connection, even after being repaired, cannot be considered seamless in the context of the present invention.

In the present invention, the term “fault” regarding to the shell means the fault on the shell that is inherently formed due to the support of the core and will result in the communication of the inner core with the environment outside the shell. Therefore, the term “faultless” regarding to the shell means that there is no fault on the shell that is inherently formed due to the support of the core and will result in the communication of the inner core with the environment outside the shell. For example, if there is a hole on the shell in order to mount a metal part, however, such a hole is not inherently present due to the support of the core during the molding process, such a hole is not considered a fault in the context of the present invention, and such shell is considered faultless in the context of the present invention. It should be appreciated that there are technologies to “repair” the fault formed during the molding of the shell, for example, by applying a “patch” of a material that can adhere to the shell effectively to cover the fault. However, such fixed shell is still considered “faulty” even after being fixed.

For example, in order to produce such a refrigerator door, wherein PS resin is used to produce the liner plate, PU foaming resin is used to produce the core, and PU elastomeric resin is used to produce the panel, it is apparent that one can form the liner plate, the core and the panel separately by conventional process, then assemble them together, and use means such as adhesion to integrate the three parts into one body. However, in the molding process, the seam at the connection of linear plate and the panel is unavoidable, although the seam can be closed by said adhesion to integrate the three parts into one body, the product still cannot be considered “substantially seamless” in the context of the present invention, because, before adhesion, molding of the product has already completed, the adhesion is merely a finishing step, not a part of the molding process.

For another example, as mentioned above, the present invention can be used to produce a refrigerator door, wherein PS resin is used to produce a liner plate, and PU foaming resin is used to produce a foamed core, and PU elastomeric resin is used to produce a panel, and the panel can have a plastic logo of the producer as a decorative insert. In the production of such a refrigerator door, the insert is first produced and steps (a) and (b) are carried our separately. Then, when step (c) is performed, the insert is first mounted onto a mold-half the second mold, followed by closing the mold, injecting PU elastomeric resin, curing and opening of the second mold, so as to obtain an integrated refrigerator door with the logo on the panel. If the logo carried a hole (“fault”), the hole will be maintained on the finished refrigerator door. However, such a hole is apparently not the fault in the context of the present invention, and the product obtained is still considered substantially faultless, no matter how big the hole is.

### Examples

The following examples illustrate the implementation of step (c) of the present invention. It should be noticed that the implementation of steps (a) and (b) are known to those skilled in the art.

Step (c) of the inventive process is implemented under various conditions to obtain refrigerator doors. The conditions used are:
Material: Panel material is Elastolit CR 8739-200 A/B (a dual component PU elastomeric resin from BASF, with the two components named as A and B); foamed core material is Elastocool CH 2030/126 C-A (a PU foaming resin from BASF); the liner plate material is Styrolux PS 2710 (blister grade PS from BASF).
Material Temperature: 25° C. for A and B component.
Mold temperature: see the table below.
Injection amount: see the table below, measured as the total of component A and B.
Ejection time: 15 min.
Injection pressure: 10 MPa for A and B component.
Injection flow: 209 g/second.
Injection time: 8.5 second.
Gelation time: 21 second.
Foamed core density: High: about 45 kg/m³, Low: about 35 kg/m³.

The finished product and some of foaming conditions are listed in the table below.

| | | Mold | | Appearance of the PU |
|---|---|---|---|---|
| | Core | temperature | Injection | elastomer refrigerator |
| Example | density | (° C.) | amount (kg) | door panel |
| 1 | High | 50 | 1.8 | Good |
| 2 | Low | 50 | 1.8 | Bad |
| 3 | Low | 60 | 1.8 | Bad |
| 4 | High | 60 | 1.8 | Good |
| 5 | High | 50 | 1.8 | Good |
| 6 | Low | 50 | 1.9 | Bad |
| 7 | Low | 50 | 2 | Bad |
| 8 | High | 50 | 1.9 | Good |

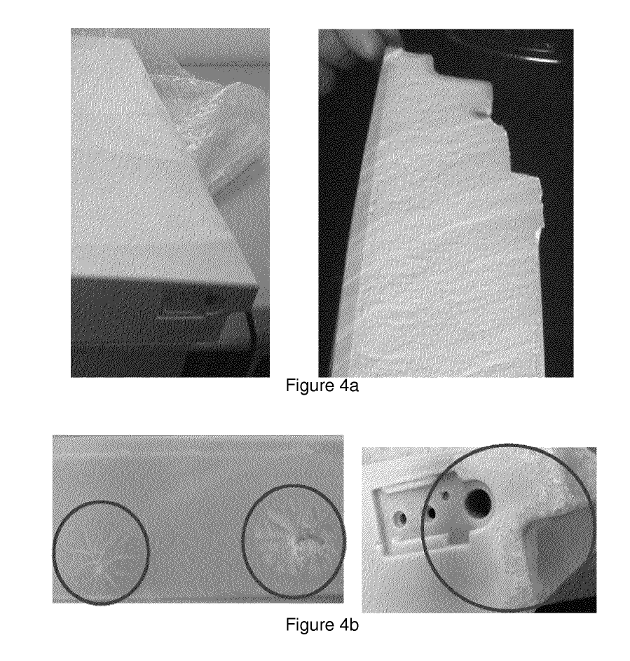

The appearance and cross section of the finished product obtained in Example 1 is shown in FIG. 4a. The left photograph shows the appearance of the refrigerator door, and the right photograph shows a cross section of the refrigerator door after it was cut from middle, wherein on the left side is the panel, on the right side is the liner plate, and in the middle is the foamed core inside the refrigerator door. It can be seen that the refrigerator door has perfect appearance, with the panel and the liner place seamlessly joined, and the refrigerator door has an integrated structure.

The appearance the finished product obtained in Example 2 is shown in FIG. 4b. It can be seen that the elastomer panel has big bubbles on its surface, and the appearance at corners and edges is poor (see the encircled parts).

From above examples, it can be seen that, with selected mold and material, under conditions tested, on one hand, by increasing mold temperature and the injection amount, although it is possible to obtain a refrigerator door which can avoid the penetration of outside material into the core, the appearance is poor and commercial value is limited; on the other hand, by controlling the density of the foamed core, it is possible to obtain a refrigerator door with better appearance.

In summary, in one aspect of the present invention, the following embodiments are implemented:
1. An article with a shell made of at least two substantially seamlessly joined parts, wherein the core is enclosed in the shell, wherein the shell and the core form an integrated structure.
2. The article of embodiment 2, wherein the shell is substantially faultless.
3. The article of embodiment 1 or 2, wherein the core is a foamed core.
4. The article of embodiment 3, wherein said foamed core is produced from PU foaming resin, wherein the density of the PU foamed core is 30-80 kg/m³ and preferably 40-80 kg/m³, and, preferably, the PU foaming resin has a free foaming density of 10-40 kg/m³.
5. The article of embodiment 4, wherein the at least two parts of the shell are produced from PS resin and/or PU elastomeric resin.
6. The article of any one of embodiments 1 to 5, which is a refrigerator door.
7. The process for the production of the article of any one of embodiments 1 to 6, comprising the following steps:
   (a) Obtain the first part of the shell with the first shell material;
   (b) Form the core with the core material on the first part of the shell, obtaining the combination of first part of the shell and the core, wherein the positioning of the core on the first part of the shell makes the core enclosed in the shell of the article;
   (c) Bring the second shell material for the second part of the shell into contact with the first part of the shell so as to form the preferably substantially faultless shell made of the first and the second parts of the shell, said first and second parts of the shell are substantially seamlessly joined together.
8. The process of embodiment 7, wherein step (b) is implemented as following:
   (b) with the first mold opened, place the first part of the shell at the bottom of the first mold half of the first mold; optionally place the related functional insert and/or structure enhancing elements; add the core material to the space within the first mold half of the first mold, above the first part of the shell, close the first and the second mold halves of the first mold, allowing the core material to form the core; at this time, the first part of the shell and the core are adhered to form the combination of the first part of the shell and the core; open the first mold to take the combination out.
9. The process of embodiment 7 or 8, wherein step (c) is implemented as following:
   (c) with the second mold opened, place the combination of the first part of the shell and the core obtained in step (b) into the forming cavity of first mold half of the second mold, with the first part of the mold contacting the bottom of the first mold half; a space is formed within the forming cavity of the first mold half, between the side wall of the mold and the core, around the core excluding the first part of the shell; optionally place the related functional insert and/or structure enhancing elements; close the first and the second mold halves of the second mold; add the second shell material into the space within the forming cavity of the first and the second mold halves of the second mold, around the core excluding the first part of the shell, forming the second part of the shell; at this time, the first and the second parts of the shell and the core are combined together, forming a integrated structure, wherein the first and the second parts of the shell are joined, forming a substantially seamless, preferably substantially faultless shell; open the second mold to obtain the article.
10. The process of any one of embodiments 7 to 9, wherein the second part of the shell is formed by RIM in step (c).
11. The process of any one of embodiments 7 to 10, wherein at least one insert is inserted into the shell.
12. The process of any one of embodiments 7 to 11, wherein at least a part of the shell is formed into bigger thickness and is then sculptured, or at least a part of the shell is formed with an exchangeable part of a partially exchangeable mold.
13. The process of any one of embodiments 7 to 12, wherein said foamed core is produced from PU foaming resin, wherein the density of the PU foamed core is 30-80 kg/m³ and preferably 40-80 kg/m³, and, preferably, the PU foaming resin has a free foaming density of 10-40 kg/m³.
14. The process of any one of embodiments 7 to 13, wherein the first party of the shell is produced from PS resin, and/or the second part of the shell material is produced from PU elastomeric resin.
15. The process of any one of embodiments 7 to 14, wherein step (c) is implemented by RIM under the condition of material temperature 10-90° C., preferably about 25° C., mold temperature of 40-100° C., preferably about 60° C.
16. A process for the production of a article, said article has a shell and a core enclosed by the shell, the shell is made of at least two substantially seamlessly joined parts, and is preferably substantially faultless, the core is a foamed core, the shell and the core forms a integrated structure; the process comprises the following steps:
   (a) Obtain the first part of the shell with the first shell material;
   (b) Form the core with the core material on the first part of the shell, obtaining the combination of first part of the shell and the core, wherein the positioning of the core on the first part of the shell makes the core enclosed in the shell of the article;
   (c) Bring the second shell material for the second part of the shell into contact with the first part of the shell so as to form the preferably substantially faultless shell made of the first and the second parts of the shell, said first and second parts of the shell are substantially seamlessly joined together;
   wherein step (c) is implemented by RIM.
17. The process of embodiment 16, wherein step (b) is implemented as following:
   (b) with the first mold opened, place the first part of the shell at the bottom of the first mold half of the first mold; optionally place the related functional insert and/or structure enhancing elements; add the core material to the space within the first mold half of the first mold, above the first part of the shell, close the first and the second mold halves of the first mold, allowing the core material to form the core; at this time, the first part of the shell and the core are adhered to form the combination of the first part of the shell and the core; open the first mold to take the combination out.
18. The process of embodiment 16 or 17, wherein step (c) is implemented as following:
   (c) with the second mold opened, place the combination of the first part of the shell and the core obtained in step (b) into the forming cavity of first mold half of the second mold, with the first part of the mold contacting the bottom of the first mold half; a space is formed within the forming cavity of the first mold half, between the side wall of the mold and the core, around the core excluding the first part of the shell; optionally place the related functional insert and/or structure enhancing elements; close the first and the second mold halves of the second mold; add the second shell material into the space within the forming cavity of the first and the second mold halves of the second mold, around the core excluding the first part of the shell, forming the second part of the shell; at this time, the first and the second parts of the shell and the core are combined together, forming a integrated structure, wherein the first and the second parts of the shell are joined, forming a substantially seamless, preferably substantially faultless shell; open the second mold to obtain the article.
19. The process of any one of embodiments 16 to 18, wherein the second part of the shell is formed by RIM in step (c).
20. The process of any one of embodiments 16 to 19, wherein at least a part of the second part of the shell is formed into bigger thickness and is then sculptured, or at least a part of the second part of the shell is formed with an exchangeable part of a partially exchangeable mold.
21. The process of any one of embodiments 16 to 20, wherein at least one insert is inserted into the shell.
22. The process of any one of embodiments 16 to 21, wherein the first shell material is PS resin, and/or the second shell material is PU elastomeric resin, and/or the core material is PU foaming resin.
23. The process of any one of embodiments 16 to 22 wherein the density of the PU foamed core is 30-80 kg/m³ and preferably 40-80 kg/m³, and, preferably, the PU foaming resin has a free foaming density of 10-40 kg/m³.
24. The process of any one of embodiments 16 to 23, wherein step (c) is implemented by RIM under the condition of material temperature of 10-90° C., preferably about 25° C., mold temperature of 40-100° C., preferably about 60° C.
25. An article obtainable by the process of any one of embodiments 16 to 24, which is a refrigerator door.

1. An article with a shell made of at least two substantially seamlessly joined parts, wherein a core is enclosed in the shell, wherein the shell and the core form an integrated structure.

2. The article of claim 1, wherein the shell is substantially faultless.

3. The article of claim 1, wherein the core is a foamed core.

4. The article of claim 3, wherein said foamed core is produced from PU foaming resin, wherein the density of the PU foamed core is 30-80 kg/m3.

5. The article of claim 4, wherein the at least two parts of the shell are produced from PS resin and/or PU elastomeric resin.

6. The article of claim 1, which is a refrigerator door.

7. The process for the production of the article of claim 1, comprising the following steps:
(a) Obtain the first part of the shell with the first shell material;
(b) Form the core with the core material on the first part of the shell, obtaining the combination of first part of the shell and the core, wherein the positioning of the core on the first part of the shell makes the core enclosed in the shell of the article;
(c) Bring the second shell material for the second part of the shell into contact with the first part of the shell so as to form the shell made of the first and the second parts of the shell, said first and second parts of the shell are substantially seamlessly joined together.

8. The process of claim 7, wherein step (b) is implemented as following:
(b) with the first mold opened, place the first part of the shell at the bottom of the first mold half of the first mold; optionally place the related functional insert and/or structure enhancing elements; add the core material to the space within the first mold half of the first mold, above the first part of the shell, close the first and the second mold halves of the first mold, allowing the core material to form the core; at this time, the first part of the shell and the core are adhered to form the combination of the first part of the shell and the core; open the first mold to take the combination out.

9. The process of claim 7, wherein step (c) is implemented as following:
(c) with the second mold opened, place the combination of the first part of the shell and the core obtained in step (b) into the forming cavity of first mold half of the second mold, with the first part of the mold contacting the bottom of the first mold half; a space is formed within the forming cavity of the first mold half, between the side wall of the mold and the core, around the core excluding the first part of the shell; optionally place the related functional insert and/or structure enhancing elements; close the first and the second mold halves of the second mold; add the second shell material into the space within the forming cavity of the first and the second mold halves of the second mold, around the core excluding the first part of the shell, forming the second part of the shell; at this time, the first and the second parts of the shell and the core are combined together, forming a integrated structure, wherein the first and the second parts of the shell are joined, forming a substantially seamless, shell; open the second mold to obtain the finished article.

10. The process of claim 7, wherein the second part of the shell is formed by RIM in step (c).

11. The process of claim 7, wherein at least one insert is inserted into the shell.

12. The process of claim 7, wherein at least a part of the second part of the shell is formed into bigger thickness and is then sculptured, or at least a part of the second part of the shell is formed with an exchangeable part of a partially exchangeable mold.

13. The process of claim 7, wherein said foamed core is produced from PU foaming resin, wherein the density of the PU foamed core is 30-80 kg/m3.

14. The process of claim 7, wherein the first part of the shell is produced from PS resin, and/or the second part of the shell material is produced from PU elastomeric resin.

15. The process of claim 7, wherein step (c) is implemented by RIM under the condition of material temperature 10-90° C., and mold temperature of 40-100° C.

16. The article of claim 4, wherein the density of the PU foamed core is 40-80 kg/m3 and the PU foaming resin has a free foaming density of 10-40 kg/m3.

17. The process of claim 7, wherein the shell made of the first and the second parts of the shell is substantially faultless.

18. The process of claim 9 wherein the first and the second parts of the shell are joined, forming a substantially faultless shell.

19. The process of claim 13, wherein the density of the PU foamed core is 40-80 kg/m3 and the PU foaming resin has a free foaming density of 10-40 kg/m3.

20. The process of claim 15, wherein step (c) is implemented by RIM under the condition of material temperature about 25° C. and mold temperature of about 60° C.
